(19) United States
(12) Patent Application Publication
(10) Pub. No.: US 2004/0168870 A1
(43) Pub. Date: Sep. 2, 2004

(54) Suspension strut unit with a stop buffer

(75) Inventors: Gunther Handke, Euerbach (DE); Manfred Schuler, Dittelbrunn (DE); Wolfgang Breun, Niederwerrn (DE); Ali Dogan, Schweinfurt (DE); Stephan Zuber, Schonungen (DE)

Correspondence Address: COHEN, PONTANI, LIEBERMAN & PAVANE, 551 FIFTH AVENUE, SUITE 1210, NEW YORK, NY, 10176, US

(73) Assignee: ZF Sachs AG

(21) Appl. No.: 10/785,901

(22) Filed: Feb. 24, 2004

(30) Foreign Application Priority Data
Feb. 28, 2003 (DE) 103 09 177.7

(51) Int. Cl. F16F 7/00

(52) U.S. Cl. 188/321.11

(57) ABSTRACT

Suspension strut unit comprising a connector bearing for a piston rod of the suspension strut unit, where a spring plate for a vehicle spring has a bearing with a connector bearing-side bearing part and a spring plate-side bearing part, which bearing allows relative rotational movement between the vehicle spring and the connector bearing of the piston rod, where, after the piston rod has traveled inward a certain distance, a stop buffer rests against a cylinder; where a second bearing allows relative movement between the connector bearing and the cylinder after the stop buffer has become active; and where the second bearing allows the stop buffer to move relative to the spring plate at an angle to the longitudinal axis of the suspension strut unit.

### BACKGROUND OF THE INVENTION

1. Field of the Invention

The invention pertains to a suspension strut including unit a cylinder, a piston rod movable axially in the cylinder, a connector bearing fixed to the piston rod, a spring plate for supporting a vehicle spring, and a stop buffer for supporting the cylinder against the connector bearing to limit axial movement between the cylinder and the connector bearing. A first bearing permits relative rotation between the spring plate and the connector bearing, and a second bearing permits relative rotation between the connector bearing and the cylinder when the stopper buffer supports the connector bearing.

2. Description of the Related Art

A suspension strut unit with a rotatable buffer support device is known from DE 83 11 927 U1. In addition to a bearing between a spring plate and a connecting element on the side facing the vehicle body, a second bearing is used, which compensates for relative movement between the connecting element and the cylinder of the suspension strut unit after the stop buffer has come to rest on the upper end surface of the cylinder. This bearing is a component of an end cap, which is pressed onto the cylinder. The two bearings make it possible for the connector bearing to be completely disconnected from the cylinder of the suspension strut unit. It is thus impossible for any twisting which could impair the comfort of the vehicle's occupants to occur between the connector bearing and the cylinder.

Although the end cap itself is comparatively simple in design, it nevertheless definitely represents an added cost.

To compensate for the transverse forces which act on the piston rod, the vehicle spring is frequently mounted at an angle to the longitudinal axis of the suspension strut unit. This means that the spring plate is also mounted at an angle. An angled spring plate which has its own bearing so that it can turn relative to the connector bearing executes a wobbling movement with respect to the end surface of the cylinder of the suspension strut unit. If a stop buffer is attached on the spring plate side, this buffer will then also wobble when the wheel is deflected, a deflection which the cylinder necessarily also performs synchronously. The radial deflection which the stop buffer executes depends very strongly on the maximum deflection angle of the wheel or of the cylinder and on the axial length of the stop buffer. If, for example, a very short stop buffer can be combined with a very large cylinder end surface, then the problem of the wobbling of the stop buffer will not occur at all under certain conditions. If the radial space available is very constricted, it is possible, for example, to attach the stop buffer to the cylinder. The stop buffer will then be disconnected from a spring plate-side component and will not execute any wobbling movements with respect to the end surface or the piston rod.

There are good reasons, however, for not attaching the stop buffer on the cylinder side. If the stop buffer were to be so attached, it would be absolutely necessary to provide it with a mounting cap. The cylinder should be as light as possible, however, because it is desirable to minimize the unsprung mass on the wheel side. Simply sliding the stop buffer over the piston rod without attaching it to the cylinder means that the stop buffer would be able to vibrate by itself in an uncontrolled manner. To prevent this, it would be necessary to center the stop buffer with a light press-fit on the piston rod, although this would increase the friction which occurs when the piston rod moves back and forth.

### SUMMARY OF THE INVENTION

The task of the present invention is to realize a suspension strut unit in which the problems associated with the attachment of the stop buffer known from the state of the art are solved.

According to the invention, the second bearing makes it possible for the stop buffer to move relative to the spring plate at an angle to the longitudinal axis.

The second bearing can thus compensate for the wobbling movement of the stop buffer even when the spring plate is mounted at an angle. The elastic volume of the stop buffer itself can be designed in the conventional manner.

In another advantageous embodiment, the output-side bearing part of the second bearing is in working connection with the spring plate-side bearing part of the first bearing. As a result, even when the cylinder and the active stop buffer perform deflecting movements, there is no relative movement in the circumferential direction between the cylinder and the stop buffer.

To simplify assembly, the output-side bearing part of the second bearing and the spring plate are designed as a single unit. This structural unit should be made of plastic where possible.

To stiffen the spring plate, the output-side bearing part of the second bearing is provided with reinforcement.

In a variant, the output-side bearing part of the second bearing has a receiving space for the stop buffer, where, between a bearing-side end surface of the stop buffer and the bottom of the receiving space, a free space is available for the stop buffer, and where a lateral surface of the stop buffer and a radial guide surface of the receiving space facing the lateral surface of the stop buffer allow the stop buffer to perform angular movements. The lateral surface and the guide surface are convex. The axial dimension of these lateral and guide surfaces can be limited to a disk-shaped area, because the angular movement of the stop buffer is also limited, and as a result the second bearing does not have to be very deep.

It is possible for the reinforcement material to form at least part of the receiving space.

In another advantageous embodiment, the output-side bearing part of the second bearing has a tension-lock connection with the stop buffer.

The tension-lock connection is formed by an expansion of the diameter of the stop buffer, which expanded area engages in at least one receptacle in the output-side bearing part of the second bearing.

The tension-lock connection on the output-side bearing part has a support surface, which supports the center of rotation for the angular movement of the stop buffer. The radii of the curved guide surface and of the lateral surface are thus determined by the distance between the center of rotation and the center axis of the suspension strut unit.

As an alternative, the output-side bearing part of the second bearing has a spheroidal bearing surface for an opposing bearing surface of the stop buffer. The stop buffer can be supported without any significant axial play on this bearing surface. Therefore, even when the cylinder is deflected, there will be no perceptible change in the spring characteristic of the stop buffer.

In another advantageous embodiment, the tension-lock connection for the stop buffer has a 3-dimensional shape concentric to the spheroidal bearing surface. The area of expanded diameter forms the opposing bearing surface of the stop buffer. The amount of axial space thus occupied is minimized, and a very simple 3-dimensional design is obtained for the output-side bearing part of the second bearing.

To simplify assembly, the radial dimension of the receptacle for the tension connection is greater than would be necessary for a defined angular movement of the stop buffer. During assembly, the stop buffer is introduced into the output-side bearing part of the second bearing in an extreme angular position, and when the buffer is pulled straight, the tension lock engages. The extreme angular position which the stop buffer assumes during assembly is never reached again in the fully assembled suspension strut unit.

According to an advantageous subclaim, the stop buffer has a pass-through opening for the piston rod, and the stop buffer also has a radial guide surface in the area of the pass-through opening, this surface resting against the piston rod. The guide surface itself is convex. When the cylinder performs a deflecting movement and the stop buffer performs its related angular movement, the stop buffer is supported on the piston rod, which always remains at the same angle to the cylinder. The piston rod now deflects the stop buffer in the second bearing in such a way that the center axis of the stop buffer becomes aligned, with a certain amount of play, with the center axis of the suspension strut unit.

By means of a third bearing, furthermore, the piston rod can be supported so that it can rotate with respect to the connector bearing. When the cylinder, during a deflecting movement, executes rotational movement relative to the connector bearing, the piston rod can rotate concomitantly in synchrony with the cylinder. It is assumed here that the friction between the cylinder and the piston rod (and the piston) is greater than the friction within the third bearing. As a result, no relative rotational movement can occur between the stop buffer and the piston rod either.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIGS. 1-3 show a stop buffer capable of angled movement with respect to the spring plate; and

FIGS. 4-7 show a stop buffer with a spheroidal surface, which opposes a bearing surface.

### DETAILED DESCRIPTION OF THE PRESENTLY PREFERRED EMBODIMENTS

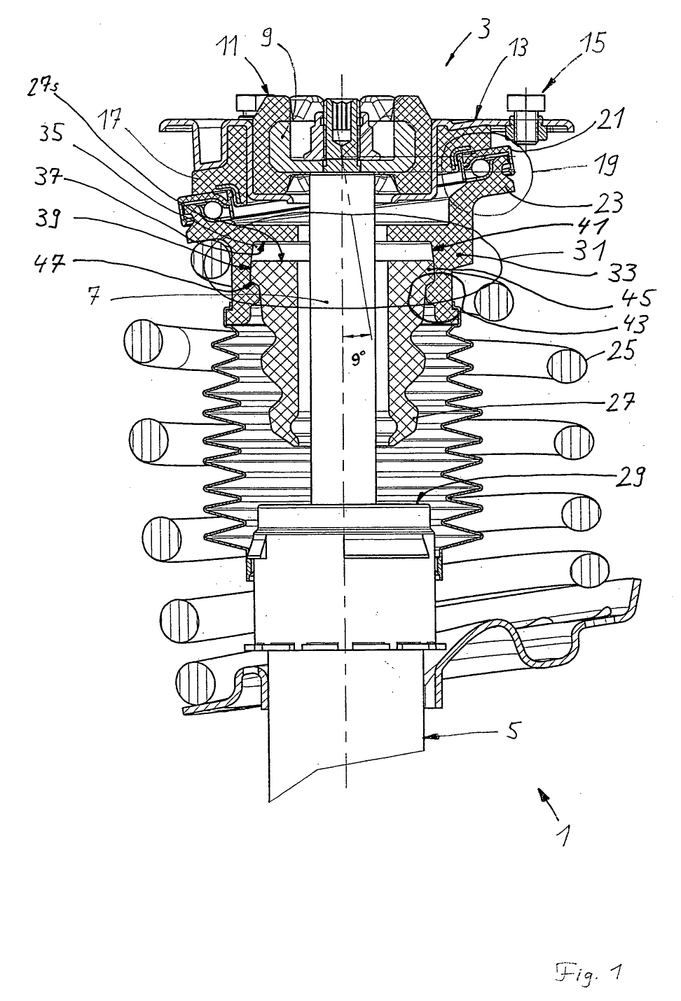

FIG. 1 shows part of a suspension strut unit 1 together with its connector bearing 3. The suspension strut unit comprises a cylinder 5, in which a piston rod 7 moves freely back and forth in the axial direction. The connector bearing has a ring-shaped base body 9 on the piston rod side, this body being enclosed on both axial sides and also radially on all sides by an elastomeric body 11. A cup-shaped carrier body 13 provides reinforcement for the connector bearing and creates a chamber for the elastomeric body with a wall on one axial side and a wall radially around the outside. In addition, the carrier body has connecting means 15, so that it can be attached to the body of the vehicle (not shown).

A second elastomeric body 17, also provided with reinforcement, is supported on the outside of the carrier body 13. The second elastomeric body carries a first bearing 19, which is at an angle to the longitudinal axis of the suspension strut unit, where a connector bearing-side bearing output part 21 is supported on the second elastomeric body, and a spring plate 23 for the vehicle spring 25 forms a bearing input part. This first bearing ensures that the vehicle spring can rotate in the circumferential direction relative to the connector bearing and thus also to the piston rod.

Concentric to the piston rod, a stop buffer 27 is fastened to the connector bearing 3. After the piston rod has traveled inward a certain distance relative to the cylinder, the stop buffer 27 comes to rest against an end surface 29 of the cylinder, or, in this case, against the end surface of a cylinder cap. To prevent the stop buffer from twisting in the circumferential direction, this component is in working connection with the bearing input part of the first bearing 19, i.e., the spring plate 23, by way of a second bearing 31. In concrete terms, an output part of the second bearing is in this case designed as an integral part of the spring plate 23. As a result, there is no relative movement in the circumferential direction between the cylinder 5, the stop buffer 27, the spring plate 23, and the vehicle spring 25.

As its output-side bearing part for the second bearing 31, the spring plate 23 has a cup-shaped base body 33 with a central pass-through opening for the piston rod 7. The base body 33 has a receiving space 35 for the stop buffer 27, and free space is available for the stop buffer between the end surface 27s of the stop buffer and the bottom 37 of the receiving space 35. The stop buffer has a lateral surface 39, which is supported with the freedom to slide along a guide surface 41 of the receiving space. The stop buffer can thus move relative to the spring plate at an angle to the longitudinal axis of the suspension strut unit.

The output-side bearing part 33 of the second bearing 31 has a tension-lock connection 43 with the stop buffer 27. The tension-lock connection 43 is formed by an expansion 45 of the diameter of the stop buffer 27, which expansion engages in a receptacle. In this case, the receptacle is the receiving space 35 in the second bearing 31. The output-side bearing part has a support surface 47, which supports the center of rotation for the angular movement of the stop buffer relative to the output-side bearing part. The lateral surface and the guide surface have rounded contours, the radii of which are approximately the same as the diameter at the transition between the guide surface 41 and the support surface 47.

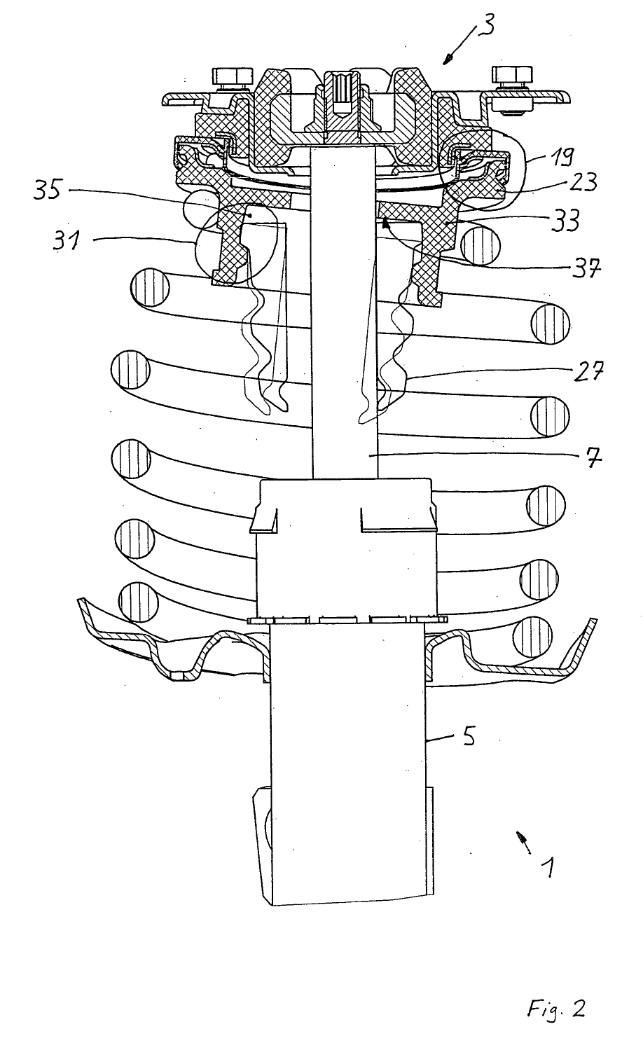

In FIG. 2 it can be seen that, when the cylinder 5 is deflected, the angular position of the cup-shaped base body 33 changes as a result of the slanted orientation of the first bearing 19. In practice, the cup-shaped base body 33 executes a wobbling movement. The stop buffer 27 is drawn in thin line to show how, if it were rigidly connected to the cup-shaped base body, it, too, would wobble in synchrony with the wobbling of the cup-shaped base body. The second bearing 31, however, makes it possible for the stop buffer to execute angular movements with respect to the spring plate 23, during which the end of the stop buffer pointing toward the cylinder 5 is supported on the piston rod 7. The stop buffer thus assumes the position shown in thick line inside the receiving space 35, where it takes advantage of the free space. When the inward travel of the piston rod is superimposed on the angular movement, the stop buffer will be supported against the bottom 37 of the receiving space 35.

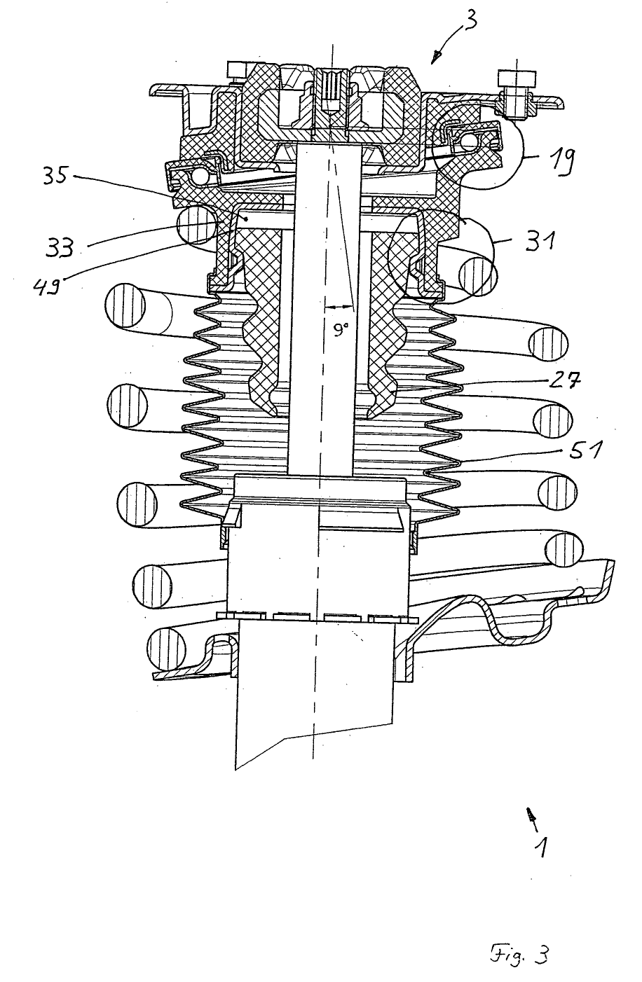

FIG. 3 shows a design which is functionally the same as the design according to FIG. 1. The difference is that the output-side bearing part 33 of the second bearing 31 now has a reinforcing element 49, which also determines the contour of the receiving space 35. Considerable forces are introduced into the base body 33 when the stop buffer goes into action. The reinforcement makes it possible for the base body to absorb a greater amount of force than it could if it were made of plastic alone. In addition, the pretension of a protective bellows 51 also acts on the base body 33.

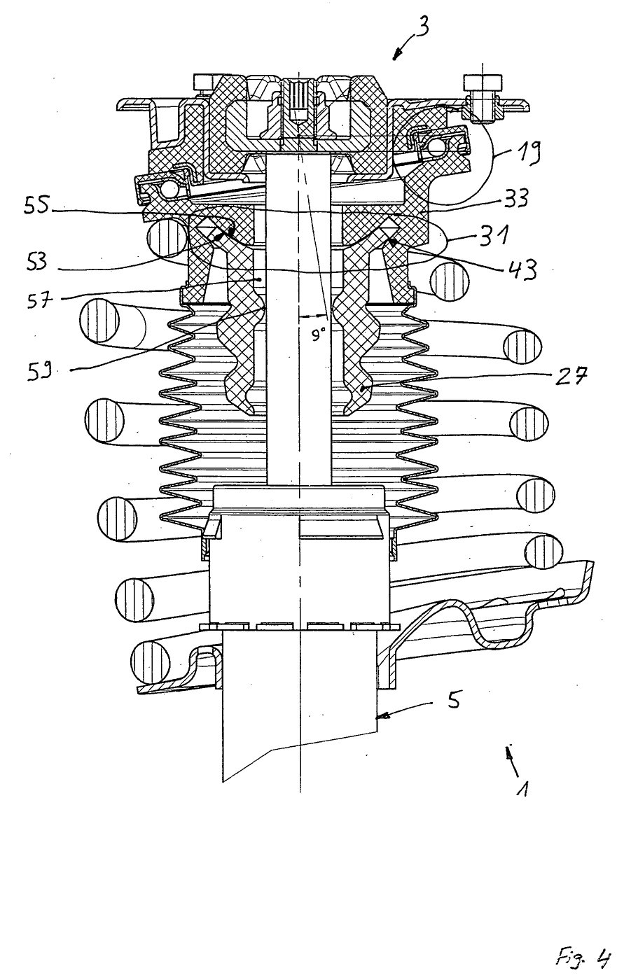

In the second design variant, shown in FIG. 4, the output side bearing part, called the base body 33 in the following, has a spheroidal bearing surface 53 for an opposing bearing surface 55 on the stop buffer 27. The bearing surface is convex in the direction away from the first bearing 19. The optimum center point for the bearing surface is at the intersection of the plane of the first bearing with the longitudinal axis of the suspension strut unit. The tension-lock connection 43 for the stop buffer has a 3-dimensional shape which is concentric to the bearing surface. In the area of a pass-through opening 57 for the piston rod, the stop buffer has a radial guide surface 59, which rests against the piston rod.

During deflecting movements of the cylinder 5, the base body 33 executes wobbling movements because of the angled position of the first bearing 19 relative to the piston rod 7. The stop buffer is supported by its guide surface 59 on the piston rod. The concave bearing surface 55 of the stop buffer slides on the convex bearing surface 53 of the base body, and the stop buffer thus executes angular movements, which compensate for the wobbling. Regardless of the angular position of the stop buffer relative to the base body, there is always a large contact area between the bearing surface of the base body and the opposing bearing surface of the stop buffer.

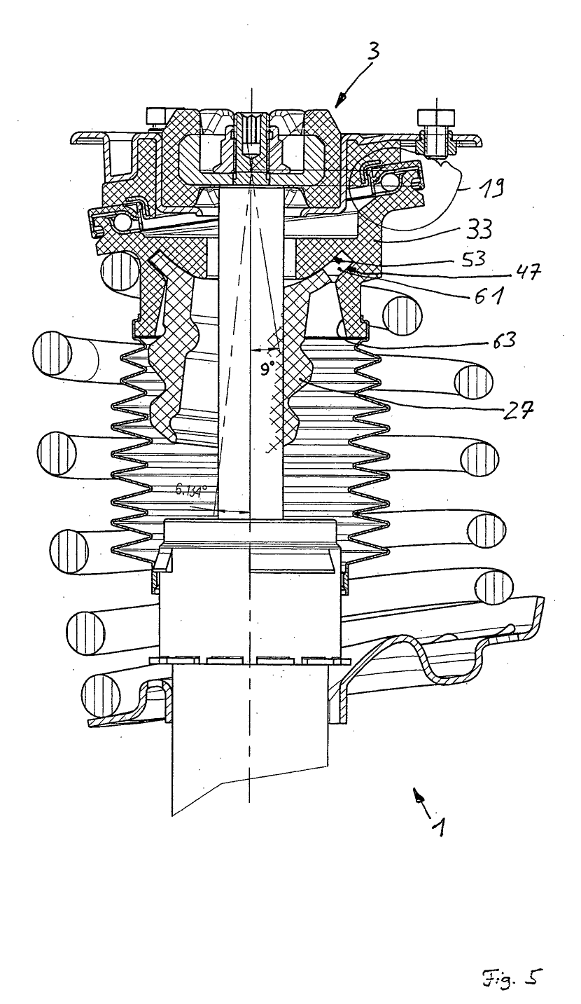

FIG. 5 shows the angular position of the stop buffer 27 of FIG. 4 in the base body 33 during the assembly procedure. The radial dimensions of the bearing surface 53 and of a receptacle 61 for the tension-lock connection of the stop buffer are larger than would be necessary for a defined maximum angular movement of the stop buffer. As a result, the tension connection between the stop buffer and the base body can be established more easily by moving the stop buffer to this extreme angle. The stop buffer never reaches this angular position again after the suspension strut unit has been installed in the chassis. As additional assembly-facilitating measures, the base body is designed with a conically tapered feed surface 63 leading to the support surface 47 of the tension-lock connection, and the transition from the feed surface to the support surface of the tension connection is provided with a transition radius.

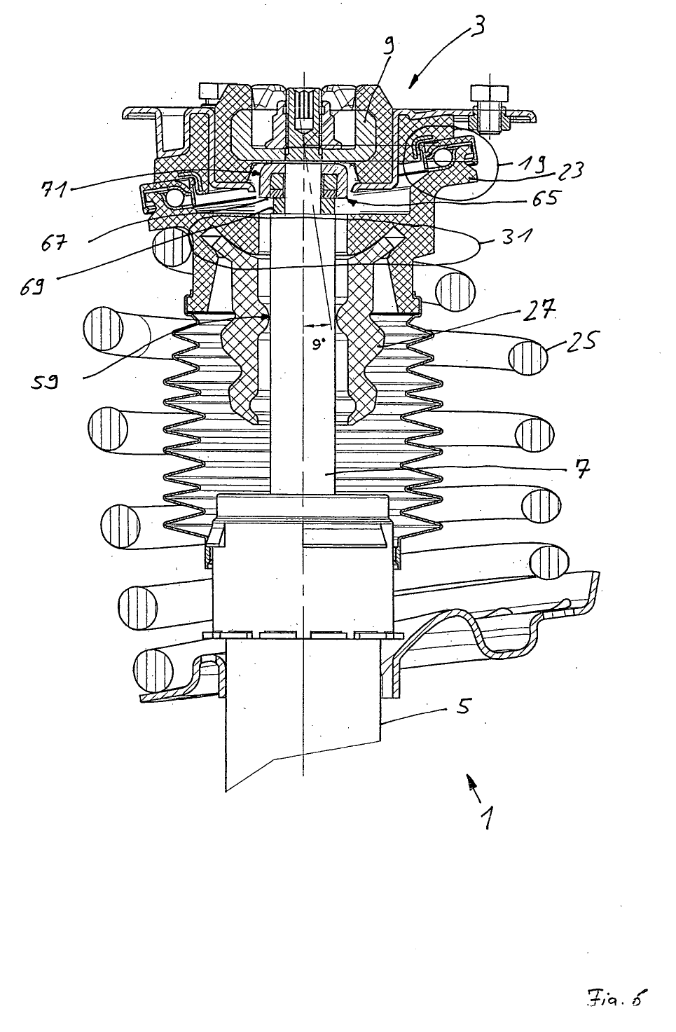

In FIG. 6, a third bearing 65 is used in addition to the first bearing 19 for the vehicle spring 25 and the second bearing 31 for the stop buffer 27; this third bearing makes it possible for the piston rod 7 to rotate relative to the connector bearing 3. This third bearing is located spatially between the ring-shaped base body 9 and a shoulder on the piston rod and thus is functionally separate from the second bearing 31, because neither the bearing input part nor the bearing output part of the second bearing is connected to the piston rod or to the base body 9.

The third bearing 65 is also designed as a slide bearing here by way of example. A slide element 67 is located between a bearing disk 69 and a bearing cup 71. Alternatively, a roller bearing could also be used at this point.

The third bearing 65 acts to prevent relative movement between the stop buffer 27 and the piston rod. Overall, thanks to the third bearing, the connector bearing is completely disconnected in the circumferential direction from the spring plate 23, from the cylinder 5, and from the stop buffer 27. Thus the angular movement of the stop buffer cannot cause any frictional forces to act in the circumferential direction between the guide surface 59 of the stop buffer and the piston rod 7.

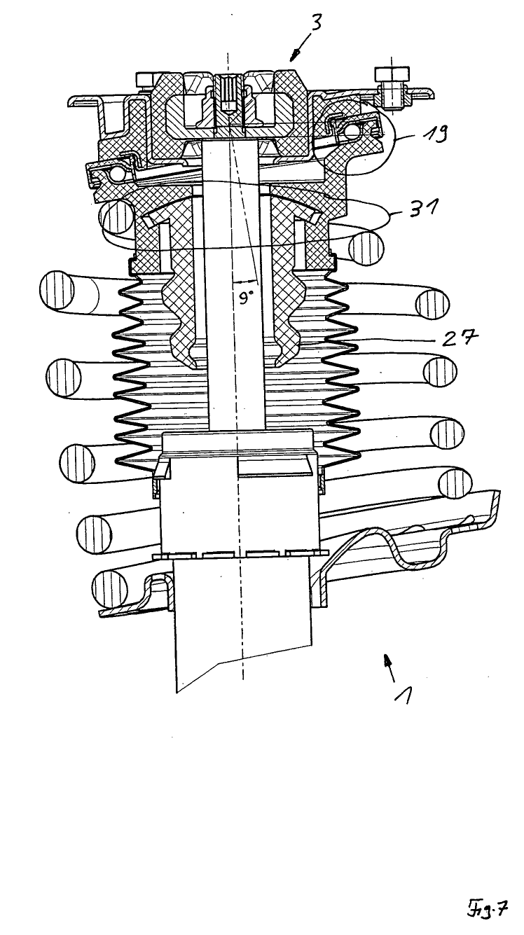

FIG. 7 is intended to show that the direction of the curvature of the spheroidal bearing surface and the opposing bearing surface of the second bearing 31 can also have a radius of curvature oriented in the direction opposite the one shown in FIGS. 4-6. The absolute value of the radius of curvature is determined by the amount of construction space available, by the length of the stop buffer 27, and especially by the maximum deflection angle which can occur, but also by the angle of the first bearing 19 to the longitudinal axis of the suspension strut unit 1. Otherwise, this variant functions in exactly the same way as the variant according to FIGS. 4 and 5, the expert being free to use the third bearing according to FIG. 6 or not.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A suspension strut unit comprising:
a cylinder having a central axis;
a piston rod movable axially in said cylinder;
a connector bearing fixed to said piston rod;
a spring plate for supporting a vehicle spring;
a stop buffer for supporting the cylinder against the connector bearing to limit axial movement between the cylinder and the connector bearing;
a first bearing which permits relative rotation between said spring plate and said connector bearing; and
a second bearing which permits relative rotation between the connector bearing and the cylinder when the stopper buffer supports the connector bearing, said second bearing permitting said stop buffer to move with respect to the spring plate at an acute angle relative to the axis of the cylinder.

2. A suspension strut unit wherein said first bearing comprises a spring plate side and said second bearing comprises an output side bearing part which is in working connection with the spring plate side of said first bearing.

3. A suspension strut unit as in claim 1 wherein said second bearing comprises an output side bearing part, said output side bearing part and said spring plate constituting a single part.

4. A suspension strut unit as in claim 2 wherein said output side bearing part comprises a reinforcing element which is formed of metal.

5. A suspension strut unit as in claim 1 wherein said second bearing comprises an output side bearing part having a receiving space with a bottom and a radial guide surface which define a receiving space, said stop buffer having an end surface and a lateral surface, said radial guide surface and said lateral surface permitting angular movement of the stop buffer relative to the output side bearing part.

6. A suspension strut unit as in claim 5 wherein said output side bearing part comprises a reinforcing element which is formed of metal, said output side bearing part forming at least part of said receiving space.

7. A suspension strut unit as in claim 1 further comprising a tension-proof connection between the output side bearing part and the stop buffer.

8. A suspension strut unit as in claim 7 wherein said output side bearing part comprises a receptacle, said stop buffer having a diametric expansion which is received in said receptacle to form said tension-proof connection.

9. A suspension strut unit as in claim 7 wherein said output side bearing part has a support surface which defines a center of rotation for angular movement.

10. A suspension strut unit as in claim 1 wherein said second bearing comprises an output side bearing part having a convex spheroidal bearing surface, and said stop buffer has a concave spheroidal bearing surface which is received against said convex spheroidal bearing surface.

11. A suspension strut unit as in claim 10 further comprising a tension-proof connection between the output side bearing part and the stop buffer, said tension-proof connection being concentric to said spheroidal bearing surfaces.

12. A suspension strut unit as in claim 11 wherein said output side bearing part comprises a receptacle which forms part of said convex spherical bearing part, and said stop buffer has a diametric expansion which forms part of said concave spherical bearing surface, said diametric expansion being received in said receptacle to form said tension-proof connection.

13. A suspension strut unit as in claim 1 wherein the stop buffer has a pass-through opening for the piston rod, said stop buffer having a radial guide surface which extends radially into the opening and rests against the piston rod.

14. A suspension strut unit as in claim 1 further comprising a third bearing which supports the piston rod for rotation with respect to the connector bearing.
